(19) United States
(12) Patent Application Publication
(10) Pub. No.: US 2025/0365715 A1
(43) Pub. Date: Nov. 27, 2025

(54) INTEGRATING FREQUENCY DOMAIN SPECTRAL SHAPING WITH SPECTRUM EXTENSION AND TONE RESERVATION

(71) Applicant: Panasonic Intellectual Property Corporation of America, Torrance, CA (US)

(72) Inventors: Xuan Tuong TRAN, Singapore (SG); Hidetoshi SUZUKI, Kanagawa (JP); Tetsuya YAMAMOTO, Kanagawa (JP); Yoshihiko OGAWA, Kanagawa (JP); Yang KANG, Singapore (SG); Hong Cheng Michael SIM, Singapore (SG)

(21) Appl. No.: 18/873,648

(22) PCT Filed: Jun. 19, 2023
(86) PCT No.: PCT/SG2023/050432

§ 371 Date: Dec. 10, 2024

(30) Foreign Application Priority Data
Jul. 1, 2022 (SG) 10202250353D

(51) Int. Cl. H04W 72/0453; H04L 5/00

(52) U.S. Cl. CPC H04W 72/0453; H04L 5/0098

(57) ABSTRACT

The present disclosure provides communication apparatuses and communication methods for integrating frequency domain spectral shaping (FDSS) with spectrum extension and tone reservation. The communication apparatuses include a communication apparatus comprising: circuitry, which in operation: determines one or more frequency components for a spectrum-10 extension (SE) part and one or more other frequency components for a non-SE part of a signal based on control information relating to the SE part and the non-SE part; generates a compensating signal based on the one or more frequency components of the SE part; and generates a reduced peak signal based on the compensating signal; and a transmitter, which in operation, transmits the 15 reduced peak signal.

### TECHNICAL FIELD

The present disclosure relates to communication apparatuses and communication methods for integrating frequency domain spectral shaping (FDSS) with spectrum extension and tone reservation.

### BACKGROUND

In third generation partnership project (3GPP) technical specification Release (Rel.) 15, NR supports frequency domain spectral shaping (FDSS) without spectrum extension for TT/2 binary phase-shift keying (BPSK) to reduce maximum power reduction (MPR) and peak-to-average power ratio (PAPR). Specifically, FDSS is to create pulses that decay faster than the basic periodic sinc-like pulses by using a FDSS filter (e.g., shaping function), so that it can reduce peak of (pulse)-sidelobes, resulting in reduction of MPR and PAPR. For example, new radio (NR) uplink (UL) transmitter 600 of FIG. 6 includes a FDSS module 602 for shaping output from Discrete Fourier transform (DFT) module 604.

MPR/PAPR can be measured in terms of output back-off (OBO) value of power amplifier (PA), which is defined as OBO=Pₛₐₜ−Pₒᵤₜ, where Pₛₐₜ is the saturated output power and Pₒᵤₜ is the actual average output power. A lower OBO value is achieved, a higher output power can be obtained from a given PA system under given emission constraints and transmit signal passband quality requirements. Therefore, a high output power can be used to improve coverage performance. In Rel. 16, the FDSS work has been continued to design lowered-PAPR demodulation reference signal (DMRS) for the case of physical uplink shared channel (PUSCH) with TT/2 BPSK to reduce the MPR/PAPR to the same level as that of data symbols.

However, there has still been no discussion on communication apparatuses and methods for integrating FDSS with spectrum extension and tone reservation.

There is thus a need for communication apparatuses and methods that provide feasible technical solutions for integrating FDSS with spectrum extension and tone reservation. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and methods for integrating FDSS with spectrum extension and tone reservation.

According to a first embodiment of the present disclosure, there is provided a communication apparatus comprising: circuitry, which in operation, determines one or more frequency components for a spectrum-extension (SE) part and one or more other frequency components for a non-SE part of a signal based on control information relating to the SE part and the non-SE part; generates a compensating signal based on the one or more frequency components of the SE part; and generates a reduced peak signal based on the compensating signal; and a transmitter, which in operation, transmits the reduced peak signal.

According to a second embodiment of the present disclosure, there is provided a base station comprising: circuitry, which in operation, generates control information relating to a spectrum-extension (SE) part and a non-SE part of a signal, the control information indicating a resource allocation for the SE part and the non-SE part in frequency domain; and a transmitter, which in operation, transmits the control information to a communication apparatus.

According to a third embodiment of the present disclosure, there is provided a communication method comprising: determining one or more frequency components for a spectrum-extension (SE) part and one or more other frequency components for a non-SE part of a signal based on control information relating to the SE part and the non-SE part; generating a compensating signal based on the one or more frequency components of the SE part; and generating a reduced peak signal based on the compensating signal; and transmitting the reduced peak signal.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR radio access network (NR-RAN) architecture to which exemplary embodiments of the present disclosure can be applied.

FIG. 2 depicts a schematic drawing which shows functional split between NG-RAN and 5G Core Network (5GC) to which exemplary embodiments of the present disclosure may be applied.

FIG. 3 depicts a sequence diagram for RRC (radio resource control) connection setup/reconfiguration procedures to which exemplary embodiments of the present disclosure may be applied.

FIG. 4 depicts a schematic drawing showing usage scenarios of Enhanced mobile broadband (eMBB), Massive Machine Type Communications (mMTC) and Ultra Reliable and Low Latency Communications (URLLC) to which exemplary embodiments of the present disclosure may be applied.

FIG. 5 shows a block diagram showing an exemplary 5G system architecture for vehicle to everything (V2X) communication in a non-roaming scenario to which exemplary embodiments of the present disclosure may be applied.

FIG. 6 shows an example illustration of a new radio (NR) uplink (UL) transmitter with FDSS (without spectrum extension) according to 3GPP Rel. 15/16.

FIG. 7 shows an example illustration of a configuration of radio resource allocations in frequency domain.

FIG. 8 shows an example illustration of another configuration of radio resource allocations in frequency domain.

FIG. 9 shows an example diagram of a NR UL transmitter with FDSS with spectrum extension (SE) and tone reservation according to various embodiments of the present disclosure.

FIG. 10 shows an example illustration of a configuration of resource allocations in frequency domain for two user equipment (UEs) according to an embodiment of the present disclosure.

FIG. 11 shows an example illustration of another configuration of resource allocations in frequency domain for two UEs according to an embodiment of the present disclosure.

FIG. 12 shows an example illustration of an integration of FDSS with spectrum extension according to an embodiment of the present disclosure.

FIG. 13 shows an example illustration of a PUSCH-Config information element (IE) according to an embodiment of the present disclosure.

FIG. 14A shows an example illustration of changing demodulation reference signal (DMRS) density in a spectrum extension (SE) part according to an embodiment of the present disclosure.

FIG. 14B shows another example illustration of changing DMRS density in a SE part according to an embodiment of the present disclosure.

FIG. 15 shows a flow chart for a UE according to various embodiments.

FIG. 16 shows a flow chart for a base station (gNB) according to various embodiments.

FIG. 17 shows a flow chart illustrating a communication method according to various embodiments.

FIG. 18 shows a schematic block diagram of an example communication apparatus in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

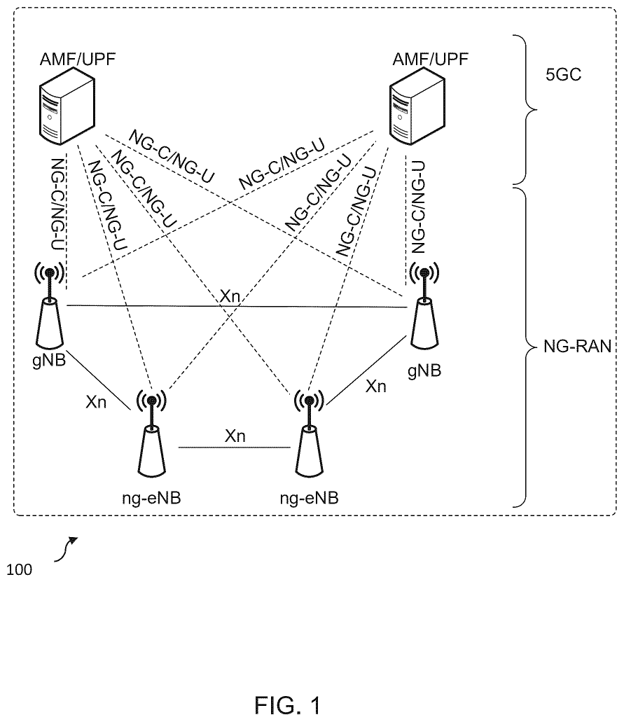

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the user equipment (UE). The gNBs are interconnected with each other by means of the Xn interface. The gNBs are also connected by means of the Next Generation (NG) interface to the NGC (Next Generation Core), more specifically to the AMF (Access and Mobility Management Function) (e.g., a particular core entity performing the AMF) by means of the NG-C interface and to the UPF (User Plane Function) (e.g., a particular core entity performing the UPF) by means of the NG-U interface. The NG-RAN architecture 100 is illustrated in FIG. 1 (see e.g., 3GPP TS 38.300 v16.3.0, section 4).

The user plane protocol stack for NR (see e.g., 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g., sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300. Further, sidelink communications is introduced in 3GPP TS 38.300 v16.3.0. Sidelink supports UE-to-UE direct communication using the sidelink resource allocation modes, physical-layer signals/channels, and physical layer procedures (see for instance section 5.7 of TS 38.300).

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are Physical Random Access Channel (PRACH), Physical Uplink Shared Channel (PUSCH) and Physical Uplink Control Channel (PUCCH) for uplink and Physical Downlink Shared Channel (PDSCH), Physical Downlink Control Channel (PDCCH) and Physical Broadcast Channel (PBCH) for downlink. Further, physical sidelink channels include Physical Sidelink Control Channel (PSCCH), Physical Sidelink Shared Channel (PSSCH), Physical Sidelink Feedback Channel (PSFCH) and Physical Sidelink Broadcast Channel (PSBCH).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10-5 within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than a mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

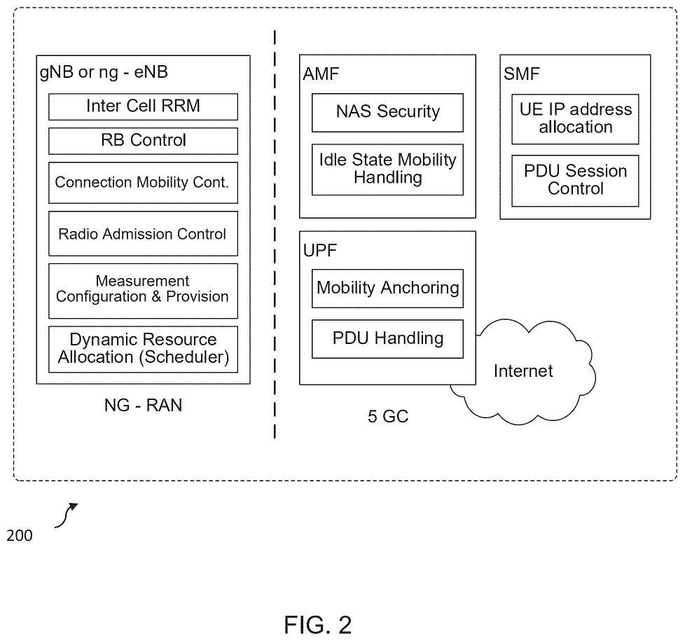

Schematic drawing 200 of FIG. 2 illustrates functional split between NG-RAN and 5GC. NG-RAN logical node is a gNB or ng-eNB. The 5GC has logical nodes Access and Mobility Management Function (AMF), User Plane Function (UPF) and Session Management Function (SMF).

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

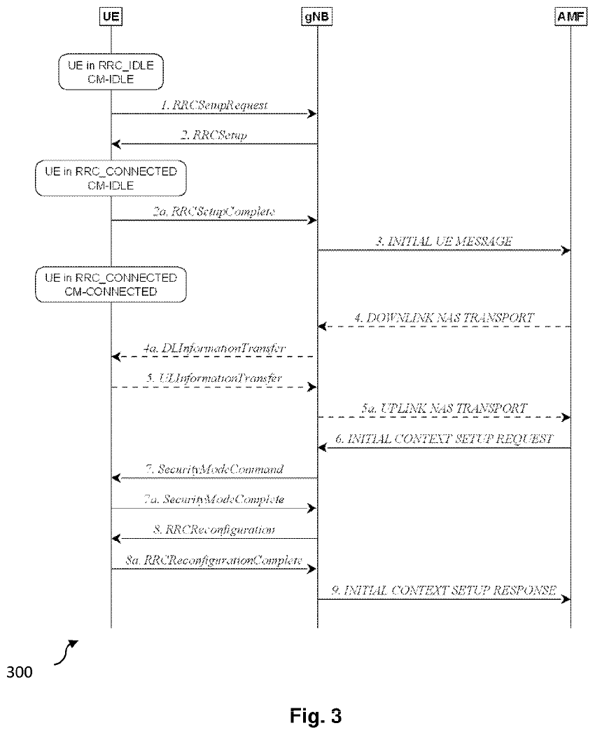

Sequence diagram 300 in FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 reference (3GPP TS 23.122: “Non-Access-Stratum (NAS) functions related to Mobile Station in idle mode”).
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signalling (protocol) used for UE and gNB configuration. In particular, this transition involves that the AMF prepares the UE context data (including e.g., PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message in response, by and, receiving the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

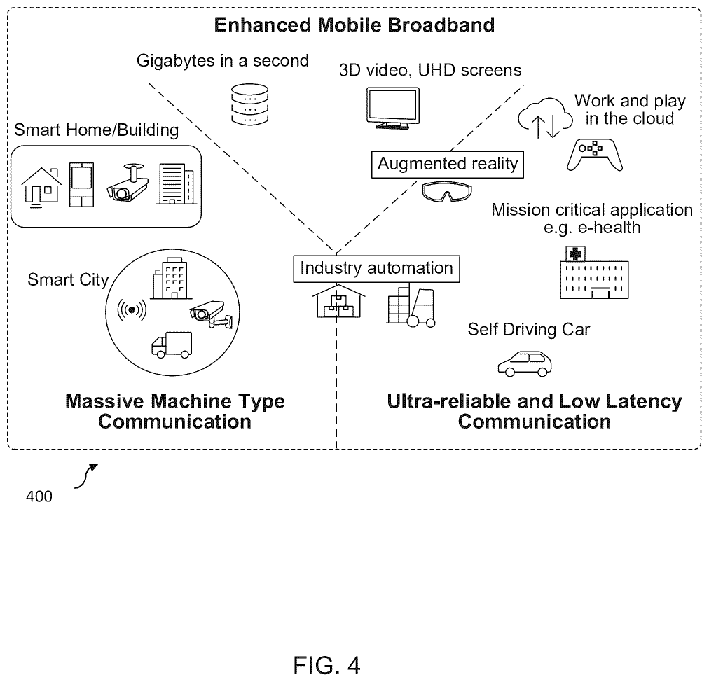

Schematic drawing 400 in FIG. 4 illustrates some use cases for 5G NR. In third generation partnership project new radio (3GPP NR), three use cases are being considered that have been envisaged to support a wide variety of services and applications by IMT-2020. The technical specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 4 illustrates some examples of envisioned usage scenarios for IMT for 2020 and beyond (see e.g., ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, mini-slot-based scheduling with flexible mapping, grant free (configured grant) uplink, mini-slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated Channel Quality Indicator/Modulation and Coding Scheme (CQI/MCS) tables for the target BLER of 1E-5.

The use case of mMTC (massive machine-type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10-6 level), higher availability, packet sizes of up to 256 bytes, time synchronization down to the order of a few us where the value can be one or a few us depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g., as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

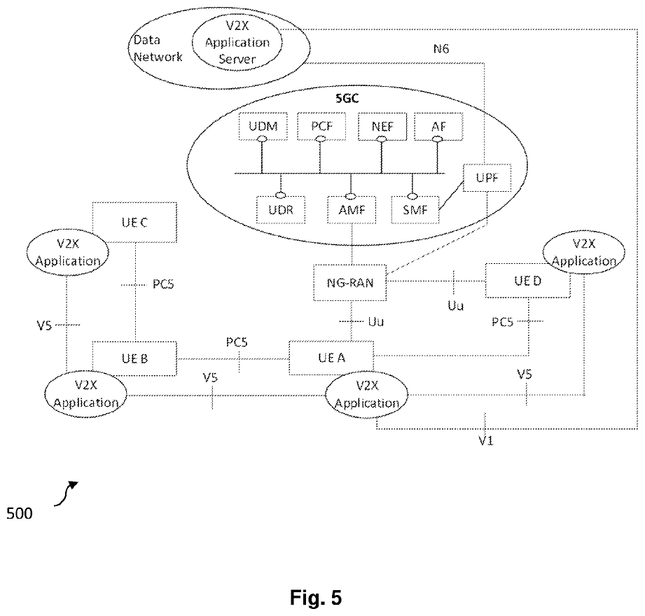

Block diagram 500 in FIG. 5 illustrates a 5G NR non-roaming reference architecture (see TS 23.287 v16.4.0, section 4.2.1.1). An Application Function (AF), e.g., an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or third party services. All of or a part of the core network functions and the application services may be deployed and running on cloud computing environments.

In Rel. 15/16 FDSS framework, a receiver of a gNB does not need to know a shaping function (e.g., FDSS filter) that is used in a UE. This approach allows UE vendors to pursue their specific shaping implementations, while the system performance is guaranteed by satisfying the minimum RF requirements (e.g., adjacent channel leakage ratio (ACLR), in-band emission (IBE), occupied bandwidth (OBW), error vector magnitude (EVM)) which are defined in specifications. IBE refers to a measure of the ratio between the power in allocated physical resource blocks (PRBs) and non-allocated PRBs inside a channel bandwidth. EVM refers to a measure of the distance between received symbols (with a test receiver) and the original symbols. OBW refers to a measure of transmit signal spectral containment, defined as the bandwidth that contains 99% of total integrated mean power. ACLR refers to another measure of the transmit signal spectral containment, particularly from an adjacent channel perspective. It can be defined as a ratio between filtered mean power centred at the considered channel and corresponding mean power at the adjacent channel. Minimum RF requirements yield boundary conditions for shaping function implemented in a UE. By defining the minimum RF requirements, a gNB does not need to know the exact FDSS filter or shaping function used in a UE. The minimum RF requirement can be different for different modulation order.

A new working item (WI) for further NR coverage enhancement (CovEnh) has been approved in Rel. 18 in [RP-213579], where one of the objectives is to reduce MPR/PAPR to improve coverage in power domain. The new WI involves the following:

Study and if necessary, specify following power domain enhancements [RP-213579]
Enhancements to realize increasing UE power high limit for carrier aggregation (CA) and dual connectivity (DC) based on Rel-17 RAN4 work on “Increasing UE power high limit for CA and DC”, in compliance with relevant regulations (The study starts after RAN4 work on “Increasing UE power high limit for CA and DC” is done depending on conclusions from RAN4. The objective will be revisited and further clarified in RAN plenary after RAN4 work on “Increasing UE power high limit for CA and DC” is done, and the discussion in WGs will not start before the objective is revised with a clearer scope. Further, both RAN1 and RAN4 are expected to be involved; to decide the order of either (RAN4, RAN1) or (RAN1, RAN4) later.).
Enhancements to reduce MPR/PAPR, including frequency domain spectrum shaping with and without spectrum extension for Direct Fourier Transform spread OFDM (DFT-S-OFDM) and tone reservation (RAN4, RAN1).

The FDSS filter (shaping function) used in a UE strongly depends on resource allocations in frequency-domain. If a size of resource allocations in frequency-domain increases, OBO value might be increased, resulting in less value of MPR/PAPR reduction. Hence, FDSS filter should be conformed to the EVM spectral flatness requirements for effectively reducing MPR/PAPR. These observations hold true for FDSS framework with and without spectrum extension. The tone reservation is to reserve tones (sub-carriers or resource allocations in frequency-domain) for a UE to generate a compensating signal that is added to the original signal in order to achieve a lowered-MPR/PAPR signal. The size of the reserved tones can impact on MPR/PAPR reduction. In summary, these above methods require their dedicated resource allocations in frequency-domain to work. However, an issue is that it is not specified in NR regarding how tone reservation and FDSS with spectrum extension (SE) for enhancing coverage performance can be realized.

An existing solution to address the above issue involves utilizing either FDSS with SE or tone reservation separately (e.g., these 2 methods are not used at the same time). Limited reduction of MPR/PAPR can be achieved, but only from each of the methods separately.

In a possible solution, a simple combination of FDSS with SE and tone reservation is used, where each component works separately on its own (e.g., To use both methods at the same time).

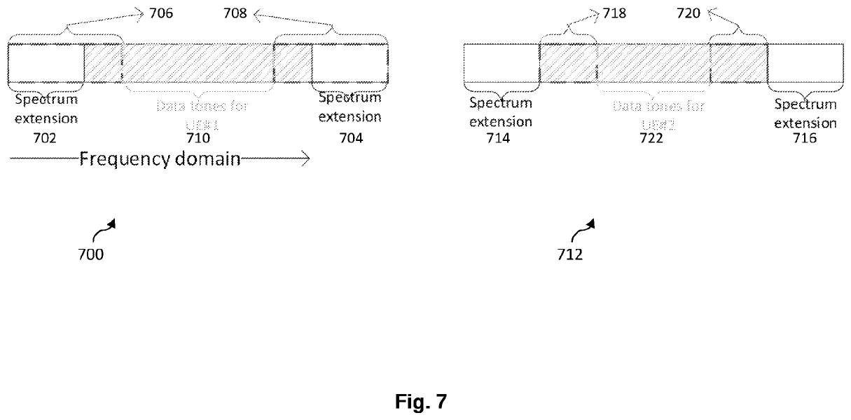

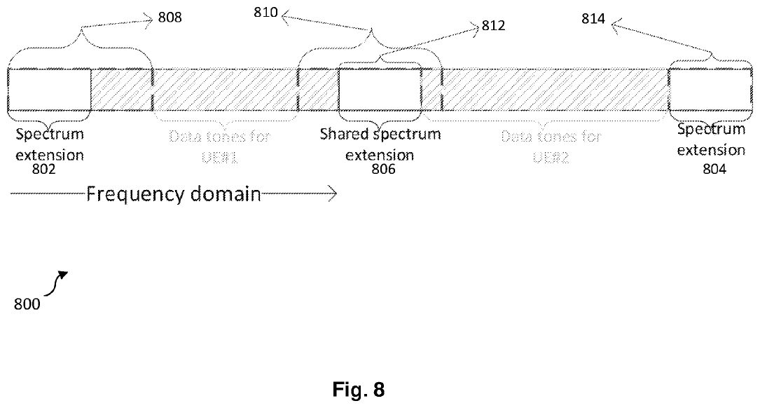

However, it may give rise to additional issues. For example, a first issue is that radio resources in frequency-domain are not fully utilized for data which results in low spectral efficiency. Referring to FIG. 7, illustration 700 shows radio resource allocation in frequency domain for a UE1 and illustration 712 shows radio resource allocation in frequency domain for a UE2. In illustration 700, SE parts 702 and 704 are added due to FDSS with SE, and peak reserved tones (PRTs) 706 and 708 are the reserved tones for UE1. However, it can be seen that only a few tones (e.g., data tones 710) from legacy resource allocations in frequency-domain in Rel. 15/16 FDSS are used for data. Similarly in illustration 712, SE parts 714 and 716 are added due to FDSS with SE, PRTs 718 and 720 are the reserved tones for UE2, and the only remaining data tones 722 are used for data.

A second issue is that the achievable reduction of MPR/PAPR may be decreased when the resource allocations in frequency-domain are not properly configured. Referring to FIG. 8, illustration 800 shows radio resource allocation in frequency domain for a UE1 and a UE2. In illustration 800, SE parts 802 and 804 as well as shared SE part 806 (e.g., shared between both UE1 and UE2) are added due to FDSS with SE, PRTs 808 and 810 are the reserved tones for UE1, and PRTs 812 and 814 are the reserved tones for UE2. As can be seen in FIG. 8, FDSS with spectrum extension and/or tone reservation do not work well because a part of the reserved tones PRT 810 for UE1 is overlapped with a part of data tones for UE2 due to improper configuration of the resource allocations. Hence, tone reservation can impact on the effect of FDSS with SE such that the achievable reduction of MPR/PAPR is decreased.

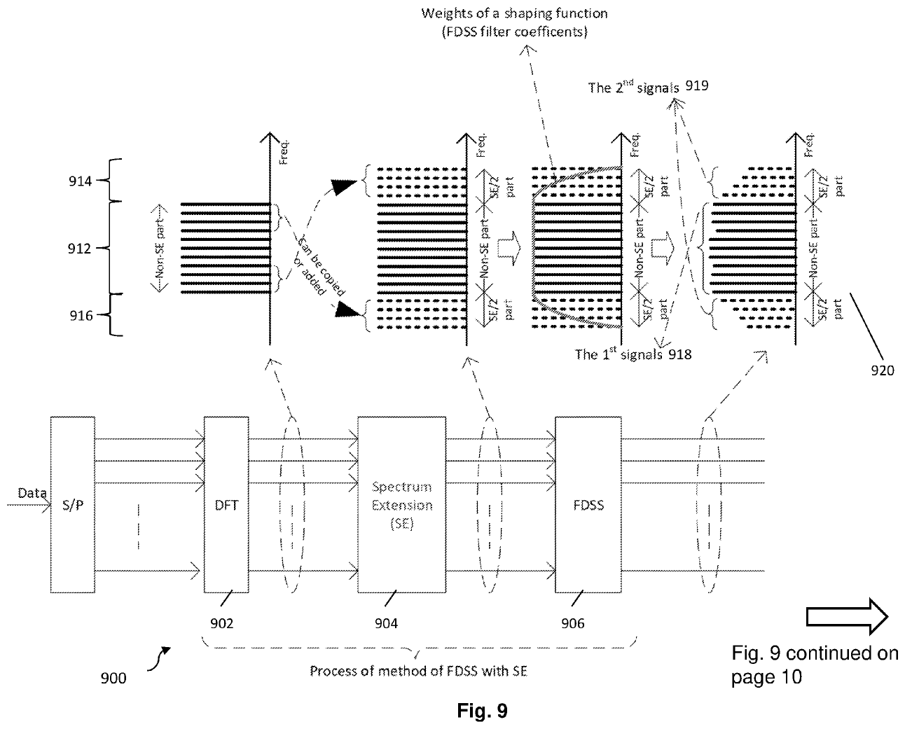

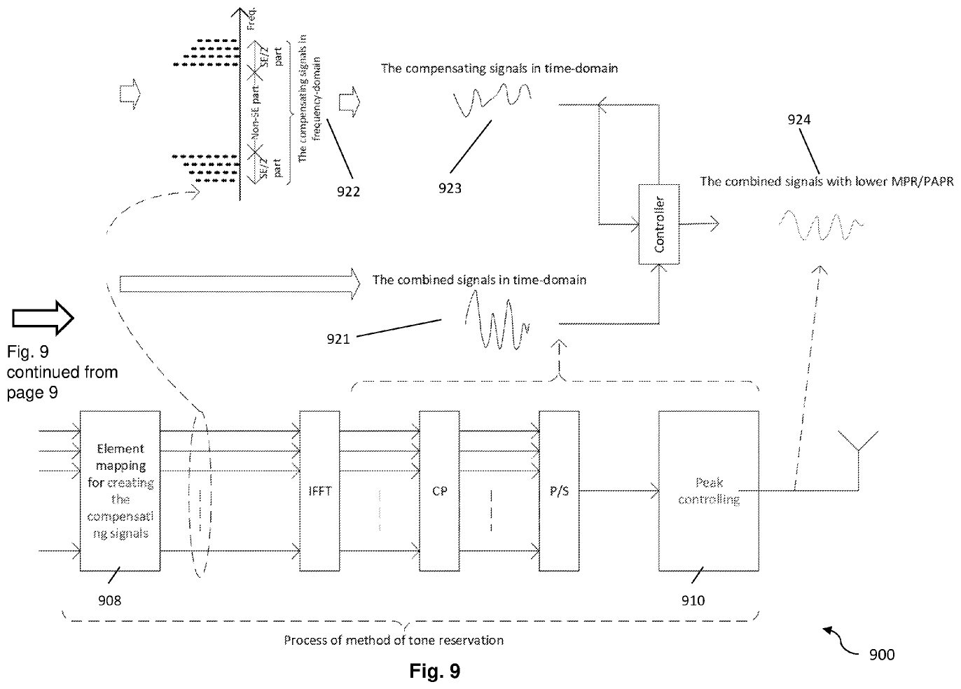

FIG. 9 shows an example diagram of a NR UL transmitter with FDSS with SE and tone reservation according to various embodiments of the present disclosure. SE parts 914 and 916 of an output signal from a Discrete Fourier Transform (DFT) process (or Fast Fourier Transform (FFT) process) (e.g., output signals of DFT module 902) are formed by copying or adding an upper portion of non-SE part 912 to an end of a lower portion of the non-SE part 912 (e.g., to form SE part 916), and copying or adding a lower portion of the non-SE part 912 to an end of the upper portion of the non-SE part 912 (e.g., to form SE part 914). Alternatively, SE parts 914 and 916 of an output signal from a DFT process (or FFT process) are formed by adding two additional portions to the upper and lower portions of the non-SE part, respectively, wherein the two additional portions can be configured by gNB or pre-configured (or pre-defined) in the technical specification. After forming the SE parts 914 and 916 (e.g., after going through SE process in SE module 904), the output signal from the SE module 904 goes through FDSS processing in a FDSS module 906, wherein the output signal is multiplied with weights (e.g., FDSS filter coefficients of a shaping function of the FDSS module 906) to get the first signals 918 that are mapped to non-SE part 912. In the other words, the output signal goes through the FDSS filter to get the first signals 918 that are mapped to non-SE part 912. Further, the second signals 919 can be obtained by multiplying a part of the output signal with other weights, and they are mapped to SE parts 914 and 916. Similarly, in the other words, a part of the output signal goes through the FDSS filter to get the second signals 919 that are mapped to SE parts 914 and 916. A plurality of sub-carriers includes a set of sub-carriers for SE parts 914 and 916 and the remaining sub-carriers for non-SE part 912.

After the FDSS process in FDSS module 906, the signal undergoes element mapping for generating compensating signals 922 in frequency domain (e.g., based on the SE parts 914 and 916) in a module 908. The first signals 918 and the second signals 919 are used to create the combined signals in frequency-domain (e.g., combined signals 920 in frequency domain before Inverse Fast Fourier Transform (IFFT) process). After IFFT process, the combined signals 920 are converted into time-domain (e.g., converted to combined signals 921 in time-domain after IFFT process). Moreover, the compensating signals 922 in frequency-domain are created by including some values for SE part and zero-values for non-SE part. After IFFT process, the compensating signals 922 are converted into compensating signals 923 in time-domain; and are used to control peak(s) of the combined signal 921 in time-domain (e.g., for a process of tone reservation) by a peak controlling algorithm in such as a controller, so that results in the combined signal 924 with lower MPR/PAPR. Alternatively, the combined signals 920 and the compensating signals 922 may be combined before Inverse Fast Fourier Transform (IFFT) process, and then the combined signals may be converted into time-domain.

In principle, in FIG. 9, the process of method of FDSS with SE includes a process of SE 904 and a process of FDSS 906, where the purpose of FDSS is to reduce peak of (pulse)-sidelobes, while the purpose of SE part is to provide a longer time separation of the neighbouring pulses to reduce further the peak. Basically, for the process of method of FDSS with SE, if SE part is large, the shorter pulse tails of sidelobes and smaller pulse amplitudes of sidelobes can be achieved. Therefore, the achievable value of MPR/PAPR may be small. On the other hand, if SE part is small, the cost is longer pulse tails of sidelobes and larger pulse amplitudes of sidelobes. Therefore, the achievable value of MPR/PAPR may be still high. Moreover, for a process of method of tone reservation, the purpose is to solve an optimization problem based on the compensating signals 922, e.g., a convex problem, in order to additionally reduce the peak of the combined signal. As it is an optimization problem, it can be solved by using an iteration algorithm.

Advantageously, it is possible to enjoy reduction of MPR/PAPR by using both methods of FDSS with SE and tone reservation such that a high output power can be used to improve coverage performance. This advantage is important because, under consideration of spectral efficiency, the SE part may be configured as small in practices such that the process of method of FDSS with SE can reduce a little bit the MPR/PAPR only. In this case, the process of method of tone reservation can contribute to additionally reduce the MPR/PAPR. Furthermore, this solution also solves the above-mentioned first and second issues because the compensating signals in tone reservation process can be mapped to only SE part to address the first issue and the second issue. In general, compared with the possible solution described in the above, where a simple combination of FDSS with SE and tone reservation is used, this solution can provide a better performance in term of MPR/PAPR and spectral efficiency, i.e., a lower value of MPR/PAPR and a higher spectral efficiency can be achieved.

In the above solution, the weights may be coefficients of a shaping function (e.g., FDSS filter). The plurality of sub-carriers can be replaced by physical resource blocks (PRBs), or resource blocks (RBs), or resource elements (REs), or bandwidth part (BWP) in frequency-domain, where 1 PRB/RB includes 12 sub-carriers, or non-overlapping sub-band full duplex (SBFD)/cross-division duplex (XDD). The non-SE part can be used for both data and DMRS, while SE part can be used for DMRS only. Hence, DMRSs in both SE part and non-SE part can be used to estimate channel for achieving diversity gain.

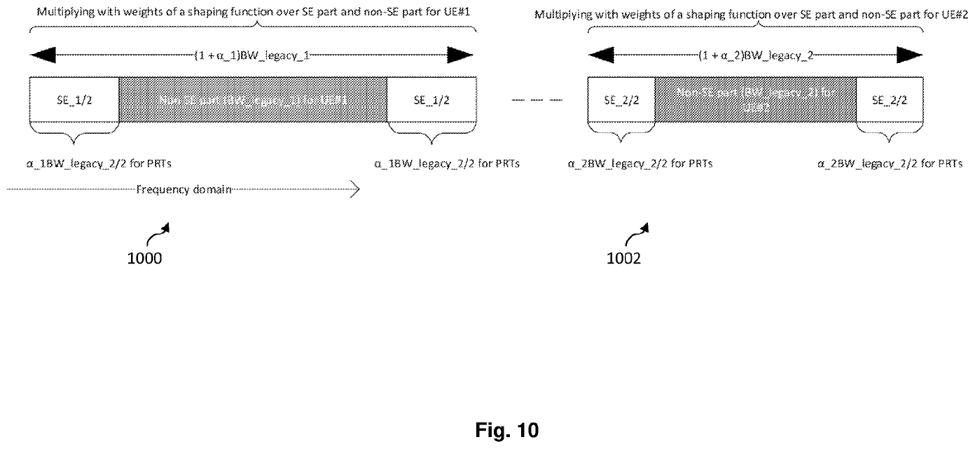

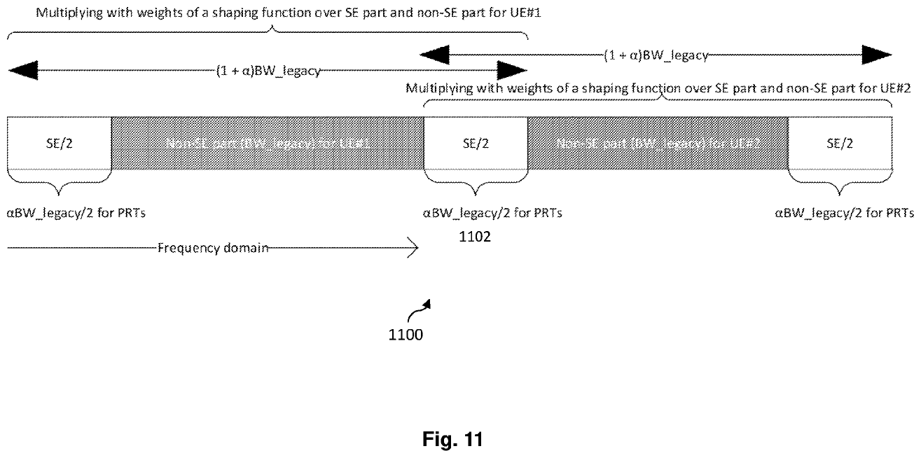

It is possible to have same or different configurations of resource allocations among two or more different UEs with overlapping SE parts. FIG. 10 shows an example of a configuration of resource allocations in frequency domain for different UEs (e.g., resource allocation 1000 for a UE #1 and resource allocation 1002 for a UE #2), wherein there are non-overlapped parts of SE between UE #1 and UE #2, and different configurations of SE and non-SE parts for each UE. Illustration 1100 of FIG. 11 shows an example of another configuration of resource allocations in frequency domain for different UEs (e.g., UE #1 and UE #2), wherein there is an overlapped part of SE (e.g., overlapped part 1102) between resource allocations for UE #1 and UE #2, and same configurations of SE and non-SE parts for both UEs.

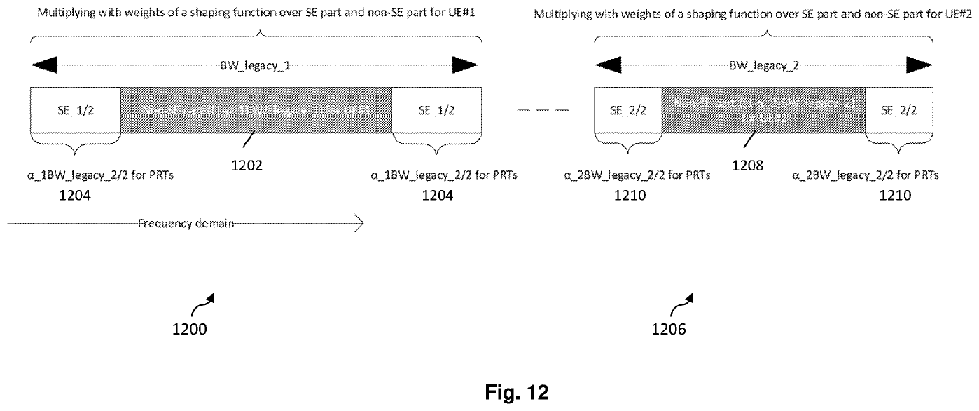

In an embodiment, a UE may receive an indication (e.g., control information) relating to a SE part and a non-SE part. Upon reception of the indication, the UE may determine the SE part and the non-SE part according to three options:
Option 1: The SE part can be deterministic (e.g., pre-defined based on a number of physical resource blocks, modulation order, and other factors as further explained below), and the non-SE part is determined based on a legacy frequency domain resource assignment (FDRA) (e.g., BW_{legacy} is used as a parameter to describe the legacy FDRA of the UE) that is specified in current technical specifications.
Option 2: The SE part is configurable based on a legacy FDRA (BW_{legacy}) and the indication (α).
The SE part can be expressed as α*BW_{legacy}. If the SE part is an additional part to BW_{legacy}, a plurality of sub-carriers for non-SE and SE parts can be expressed as (1+α)*BW_{legacy}, where BW_{legacy} is the non-SE part, e.g., shown in FIGS. 10 and 11.
If both non-SE part and SE part are confined within BW_{legacy}, the non-SE part can be expressed as (1−α)*BW_{legacy}. For example referring to FIG. 12, both non-SE part 1202 (e.g. expressed as (1−α)*BW_{legacy}1) and SE parts 1204 (e.g., expressed as α*BW_{legacy}1) for a UE #1 are confined within BW_{legacy}1 in resource allocation 1200, and both non-SE part 1208 (e.g. expressed as (1−α)*BW_{legacy}2) and SE parts 1210 (e.g., expressed as α*BW_{legacy}2) for a UE #2 are confined within BW_{legacy}2 in resource allocation 1206.
When a is a constant value or specified in specifications, Option 2 can be considered as a variation of Option 1.
Alternatively, a may be small in a case the non-SE part is large, and a may be large in a case the non-SE part is small. In other words, the SE part may become small in a case the non-SE part is large, and the SE part may become large in a case the non-SE part is small.
Alternatively, a ratio of the SE part to the non-SE part may become small in a case the non-SE part is large, and a ratio of the SE part to the non-SE part may become large in a case the non-SE part is small.
Option 3: SE part and non-SE part can be configurable based on the indication including a parameter pair, e.g., (α, β), respectively.

For Options 1-3 described above, SE part of a UE should not be overlapped with non-SE part of another UE because that might impact on reducing MPR/PAPR. Same DMRS density may be applied for both SE and non-SE parts. A UE may determine transport block size (TBS) for PUSCH based on total number of sub-carriers in non-SE part. When SE part is an additional part to non-SE part (e.g., additional to BW_{legacy}) in Option 2, the broader the non-SE part is, the broader the SE part can be. In a case of broad non-SE part, narrow SE part may be sufficient.

In Option 1, upon reception of the control information, a UE understands that the integration of FDSS with SE and tone reservation is triggered. The SE parts may be deterministic (e.g., pre-defined) as a number of physical resource blocks (PRBs) (e.g., 1 PRBs, 2 PRBs, etc). Alternatively, the SE parts may be determined based on a modulation order (e.g., the SE part may include less sub-carriers for lower modulation order, but more sub-carriers for higher modulation order. This is because high modulation order can create high PAPR, hence more sub-carriers for SE part are needed to reduce this high PAPR. For example, the SE part may include 2 PRBs for TT/2 BPSK/QPSK, but include 4 PRBs for a higher modulation order). Alternatively, the SE part may be dependent on a size of the legacy FDRA (e.g., the SE part may include less sub-carriers for a small legacy FDRA and include more sub-carriers for the broad legacy FDRA. For example, the SE part may include 2 PRBs if the legacy FDRA includes 4 PRBs, and include 4 PRBs if the legacy FDRA includes 20 PRBs). The control information may be signalled by an indication in downlink control information (DCI), e.g., a reserved bit may be used. If the reserved bit value is “1”, it means the integration is “triggered”. Otherwise, the integration is “not triggered”. Alternatively, the indication may be indicated in MAC Control Element (MAC CE) or Radio Resource Control (RRC) (e.g., A new entry is proposed in PUSCH-Config, such as FDSSwSEnTR=ENUMERATED {triggered, not_triggered}), or an implicit indication based on another signalling or configuration from a base station (gNB) (e.g., A new entry is proposed in PUSCH-Config, such as FDSSwSEnTR=ENUMERATED {triggered, not_triggered}). By utilizing indication in MAC CE/RCC or implicit indication by another signalling or combination, it is possible to save signalling overhead. Note that the dependency of modulation order and the SE part can be taken into account to calculate candidate value of a by gNB in below Option 2, and candidate values of (α, β) in below Option 3, for a purpose of defining the SE part in these options.

In Option 2, upon reception of the control information, a UE understands that integration of FDSS with SE and tone reservation is triggered and it uses the indication to determine SE part and non-SE part of a signal. The indication (α) can be signalled by an indication in DCI (e.g., A list of candidate values of α is configured by MAC-CE/RRC, for example {0.1, 0.2}, and a reserved bit in DCI can be used to indicate one of the values to be used for a), an indication in MAC CE or RRC, or an implicit indication based on another signalling or configuration from a gNB.

Indication in MAC CE/RRC for Option 2 may be based on a bitmap-based approach (e.g., When a size of the legacy FDRA (BW_{legacy}) is N sub-carriers (or PRBs), the length of bitmap is N bits. If a bit value in the bitmap is “0”, this sub-carrier (or PRB) is used for SE part. If it is “1”, this sub-carrier (or PRB) is used for non-SE part. For example, when the legacy FDRA has 4 contiguous PRBs and the bitmap is signalled as 0110, the UE can determine that the first and fourth PRBs correspond to SE part, while the second and third PRBs correspond to non-SE part. Alternatively, indication in MAC CE/RRC for Option 2 may be a value-based approach, e.g., a is signalled as a value from a list of candidate values, such as {0.1, 0.2, 0.3, 0.4, 0.5, 0.6, 0.7, 0.8, 0.9}. For example, when the legacy FDRA has 10 contiguous PRBs and a is signalled as 0.2, the UE can determine that the first and the last PRBs correspond to SE part, while the remaining PRBs correspond to non-SE part. It will be appreciated that there can be other possibilities for the list of candidate values for a.

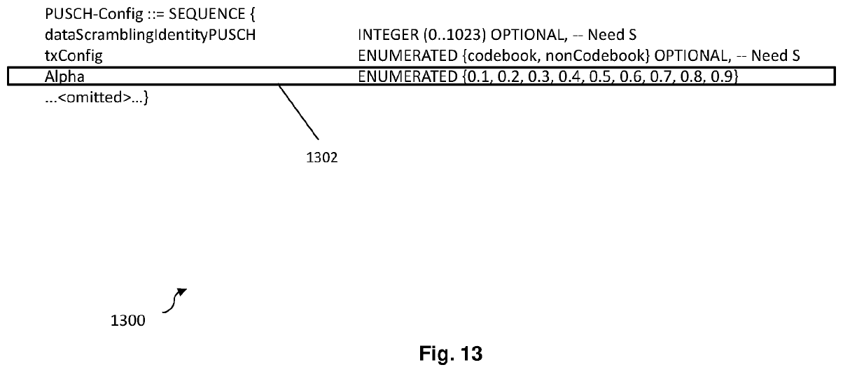

Further, for signalling for Option 2, an indication such as an Alpha information element (IE) may be proposed in PUSCH-Config IE to trigger an integration of FDSS with SE and tone reservation; and a UE may use the IE to determine SE part and non-SE part. For example, FIG. 13 shows an illustration of PUSCH-Config IE 1300 according to Option 2, wherein a set of candidate values for Alpha is listed as {0.1, 0.2, 0.3, 0.4, 0.5, 0.6, 0.7, 0.8, 0.9}, wherein one of the candidate values is indicated for Alpha (see reference 1302). Currently, for uplink resource allocation of type 1, the legacy FDRA is indicated by FDRA bit field in DCI consisting of a resource indication value (RIV) corresponding to a starting virtual resource block RBₛₜₐᵣₜ and a length in terms of contiguously allocated resource blocks L_{RBs}. For the integration of FDSS with SE and tone reservation, the FDRA bit field may be reused to indicate RIVs for SE part and non-SE part according to the following operations, where RIV_{SE_1} and RIV_{SE_2} are RIVs for upper and lower subparts of SE part, respectively, while RIV_{non-SE} is RIV for non-SE part, in accordance with the following formula:

$$If ( {L}_{RBs} - 1 ) \leq ⌊ {N}_{BWP}^{size} / 2 ⌋ then$$

$$RIV = {N}_{BWP}^{size} ( {L}_{RBs} - 1 ) + {RB}_{start}$$

$${RIV}_{SE \_ 1} = {RIV}_{SE \_ 2} = ⌊ Alpha * RIV / 2 ⌋$$

$${RIV}_{non - SE} = RIV - {RIV}_{SE \_ 1} - {RIV}_{SE \_ 2}$$

$$Else , RIV = {N}_{BWP}^{size} ( {N}_{BWP}^{size} - {L}_{RBs} + 1 ) + ( {N}_{BWP}^{size} - 1 - {RB}_{start} )$$

$${RIV}_{SE \_ 1} = {RIV}_{SE \_ 2} = ⌊ Alpha * RIV / 2 ⌋$$

$${RIV}_{non - SE} = RIV - {RIV}_{SE \_ 1} - {RIV}_{SE \_ 2}$$

$$where {L}_{RBs} \geq 1 and shall not exceed ( {N}_{BWP}^{size} - R {B}_{start} )$$

Further, implicit indication based on another signalling or configuration from a gNB may be provided based on a table of candidate values of α configured by MAC-CE/RRC, MCS bit field (or other existing bit field) that is repurposed to indicate a row index of the table which includes a value of a, e.g., Table 1 as shown below. The indication a may also be utilized to indicate non-SE part and SE part jointly in Option 2.

TABLE 1
Candidate value of α

| MCS index | Value of α |
|---|---|
| 0 | 0.1 |
| 1 | 0.2 |
| . . . | . . . |

In Option 3, upon reception of the control information, the UE understands that the integration of FDSS with SE and tone reservation is triggered and it uses the pair parameter (α, β) as the indication to determine the SE part and the non-SE part separately. α indicates a set of sub-carriers for the SE part, while β indicates another set of sub-carriers for the non-SE part. The signalling approaches for Option 2 can also be used to indicate the pair parameter (α, β) for Option 3. For example, based on the value-based approach for Option 2, (α, β) may be signalled for Option 3 as a pair from a list of candidate pairs, such as {(2, 2), (2, 4), etc.}, wherein the units of α and β are PRB. Among Options 1-3, there is no explicit indication for determination of SE part in Option 1, whereas there is an explicit indication for determination of SE part in Option 2 (e.g., a) and Option 3 (e.g., (α, β)).

In an embodiment, the SE part can be less than or equal to a certain size of PRBs. The certain size may be configured to be small in a frequency range 1 (FR1) and large in a frequency range 2 (FR2), where the frequency bands of FR2 are higher than that of FR1. That might result in a lower OBO value of power amplifier. If a lower OBO value is achieved, a larger output power could be obtained while still meeting the minimum RF requirements. For example, SE part may be configured or pre-configured to be less than or equal to 2 PRBs and 6 PRBs in FR1 and FR2, respectively.

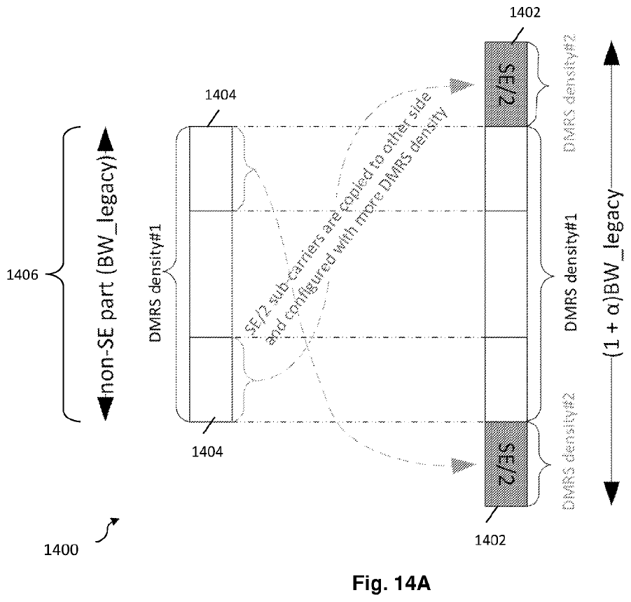

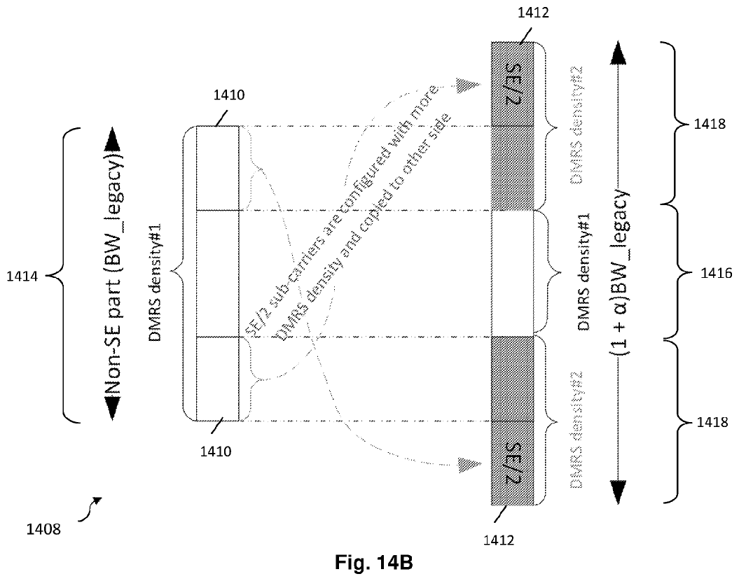

In an embodiment, different DMRS densities may be applied for the SE part and the non-SE part. For example, referring to illustration 1400 of FIG. 14A, a set of sub-carriers (e.g., SE/2 sub-carriers) from an upper side and a lower side (e.g., references 1404) in non-SE part 1406 are copied to place in a lower side and an upper side of DFT output respectively to form SE part 1402 and configured with more DMRS density (from DMRS density #1 to DMRS density #2) in FDSS with SE (e.g., DMRS density #2 is configured for the SE part 1402, while DMRS density #1 is configured for the non-SE part 1406). The operation is done for both sides of the DFT. This advantageously improves channel estimation.

In an embodiment, different DMRS densities may be applied for SE part and non-SE part as shown in illustration 1408 of FIG. 14B. A set of sub-carriers (e.g., SE/2 sub-carriers) from an upper/lower side (e.g., references 1410) of DFT output in non-SE part 1414 are configured with more DMRS density (from DMRS density #1 to DMRS density #2), and then copied to place in the other side of DFT output in FDSS with SE as SE parts 1412 (e.g., a middle subpart of non-SE part is configured with DMRS density #1 (e.g., reference 1416), while upper and lower subparts of the non-SE part are configured with DMRS density #2 as same as that of SE part (e.g., references 1418).). The operation is done for both sides of DFT output. This advantageously improves channel estimation.

In an embodiment, the size of a SE part may be determined based on one or a combination of spectral efficiency and/or a value of MPR/PAPR (for example, an optimal value of MPR/PAPR reduction may be set and used for the determination of the size of the SE part). The SE part may be a UE-specific value, or a UE type-specific value, or a serving-cell-specific value, based on the control information received from a gNB, and/or dependent on which value that the gNB allows. In Options 2 and 3, if α=0, there is only non-SE part, the high-level solution becomes FDSS without both SE and tone reservation which is equivalent to a fallback solution as specified in Rel. 15/16 FDSS. It will be appreciated that all embodiments and options described above are applicable for all uplink channels and signals.

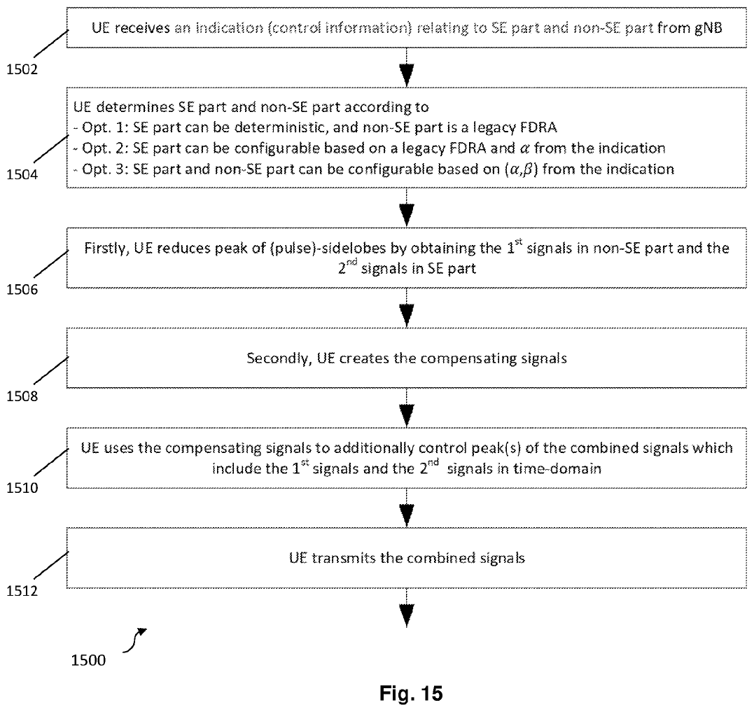

FIG. 15 shows a flow chart 1500 for a UE according to various embodiments. In a step 1502, a UE receives an indication (control information) relating to a SE part and a non-SE part from a gNB. In a step 1504, the UE determines the SE part and non-SE part according to an Option 1 (e.g., SE part may be deterministic, and non-SE part is a legacy FDRA), Option 2 (e.g., SE part may be configurable based on a legacy FDRA and α from the indication), or Option 3 (e.g., SE part and non-SE part may be configurable based on (α, β) from the indication). In a step 1506, the UE reduces a peak of pulse-sidelobes by obtaining a first signal in the non-SE part and a second signal in the SE part. In a step 1508, the UE generates compensating signals. In a step 1510, the UE uses the compensating signals to additionally control peak(s) of a combined signal which include the first and second signals in time-domain. In a step 1512, the UE transmits the combined signal.

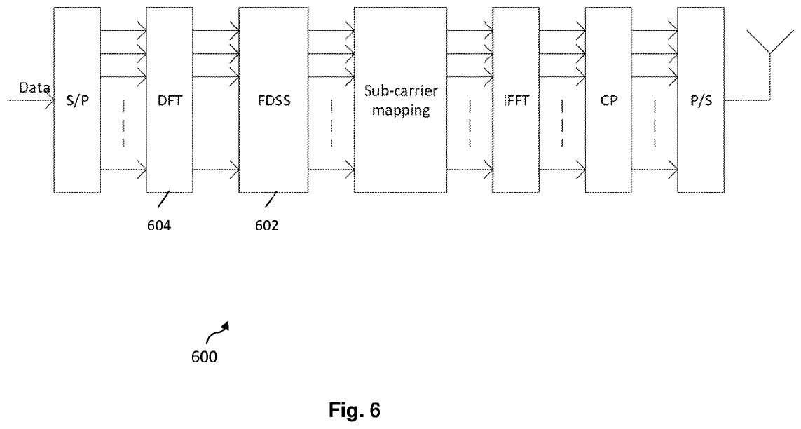

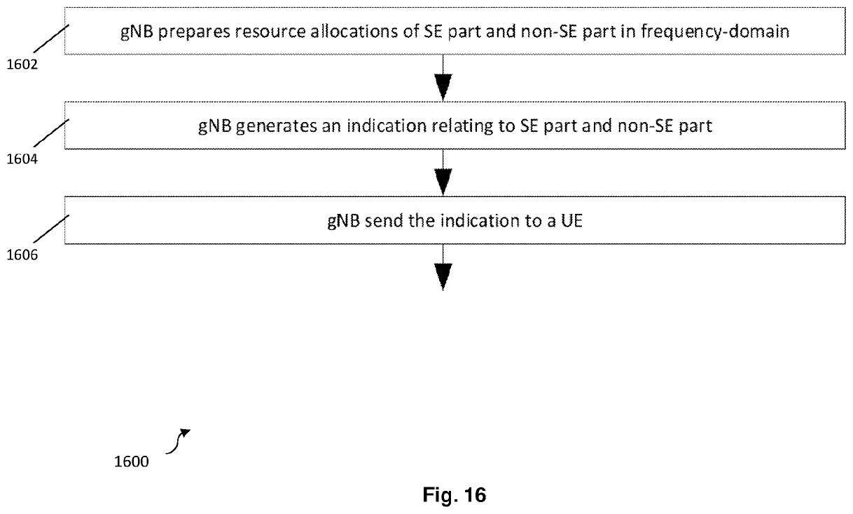

Based on different criterions described in the above embodiments and examples along with FIGS. 1 to 15, a base station or gNB prepares resource allocations of the SE part and non-SE part, and generates the corresponding control information relating to the SE part and non-SE part to send to a UE to perform FDSS with spectrum extension and tone reservation in order to reduce the peak(s) of uplink transmission. Therefore, it allows the UE to transmit the uplink channels or signals at a higher output power to improve coverage performance while still meeting the minimum RF requirements. Further, the base station or the gNB may be configured to receive the uplink channels or signals, which is generated based on the above example and embodiments at a UE and is transmitted from the UE. Further, the base station or the gNB may be configured to demodulate the received uplink channels or signals by using only non-SE part or using both the non-SE part and SE part. FIG. 16 shows a flow chart 1600 for a base station (e.g., a gNB) according to various embodiments. In a step 1602, a gNB prepares resource allocations of a SE part and a non-SE part in frequency domain. In a step 1604, the gNB generates an indication (e.g., control information) relating to a SE part and non-SE part. In a step 1606, the gNB transmits the indication to a UE.

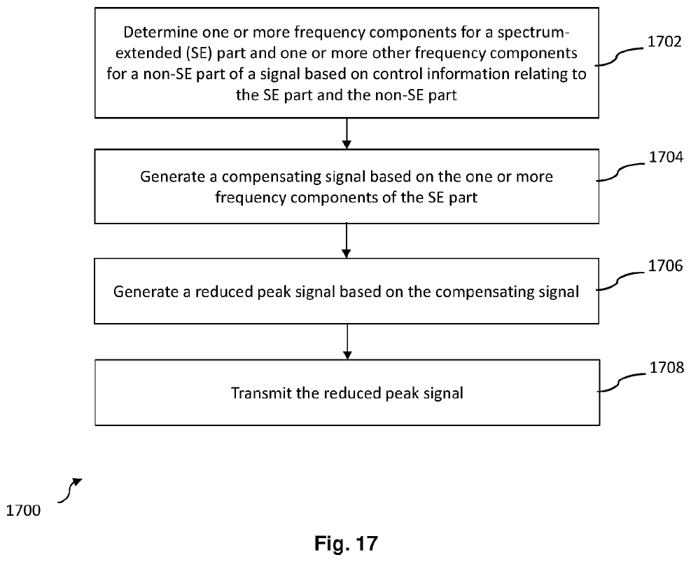

FIG. 17 shows a flow diagram 1700 illustrating a communication method according to various embodiments. In step 1702, one or more frequency components for a spectrum-extension (SE) part and one or more other frequency components for a non-SE part of a signal are determined based on control information relating to the SE part and the non-SE part. In a step 1704, a compensating signal is generated based on the one or more frequency components of the SE part. In a step 1706, a reduced peak signal is generated based on the compensating signal. In a step 1708, the reduced peak signal is transmitted.

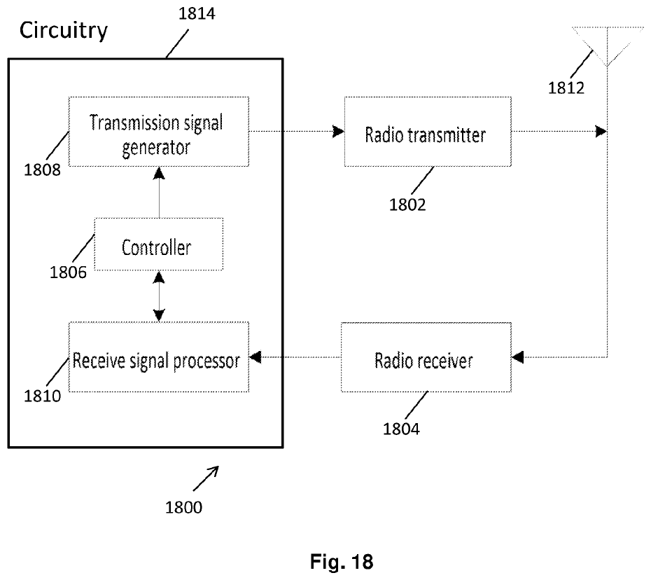

FIG. 18 shows a schematic, partially sectioned view of the communication apparatus 1800 that can be implemented for in accordance with various embodiments and examples as shown in FIGS. 1 to 17. The communication apparatus 1800 may be implemented as a UE or base station according to various embodiments.

Various functions and operations of the communication apparatus 1800 are arranged into layers in accordance with a hierarchical model. In the model, lower layers report to higher layers and receive instructions therefrom in accordance with 3GPP technical specifications. For the sake of simplicity, details of the hierarchical model are not discussed in the present disclosure.

As shown in FIG. 18, the communication apparatus 1800 may include circuitry 1814, at least one radio transmitter 1802, at least one radio receiver 1804, and at least one antenna 1812 (for the sake of simplicity, only one antenna is depicted in FIG. 18 for illustration purposes). The circuitry 1814 may include at least one controller 1806 for use in software and hardware aided execution of tasks that the at least one controller 1806 is designed to perform, including control of communications with one or more other communication apparatuses in a wireless network. The circuitry 1814 may furthermore include at least one transmission signal generator 1808 and at least one receive signal processor 1810. The at least one controller 1806 may control the at least one transmission signal generator 1808 for generating signals (for example, a signal indicating a geographical zone) to be sent through the at least one radio transmitter 1802 to one or more other communication apparatuses and the at least one receive signal processor 1810 for processing signals (for example, a signal indicating a geographical zone) received through the at least one radio receiver 1804 from the one or more other communication apparatuses under the control of the at least one controller 1806. The at least one transmission signal generator 1808 and the at least one receive signal processor 1810 may be stand-alone modules of the communication apparatus 1800 that communicate with the at least one controller 1806 for the above-mentioned functions, as shown in FIG. 18. Alternatively, the at least one transmission signal generator 1808 and the at least one receive signal processor 1810 may be included in the at least one controller 1806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1802, at least one radio receiver 1804, and at least one antenna 1812 may be controlled by the at least one controller 1806.

The communication apparatus 1800, when in operation, provides functions required for integrating FDSS with spectrum extension and tone reservation. For example, the communication apparatus 1800 may be a UE, and the circuitry 1814 may, in operation, determine one or more frequency components for a spectrum-extension (SE) part and one or more other frequency components for a non-SE part of a signal based on control information relating to the SE part and the non-SE part; generate a compensating signal based on the one or more frequency components of the SE part; and generate a reduced peak signal based on the compensating signal. The transmitter 1802 may, in operation, transmit the reduced peak signal.

The reduced peak signal may be generated by adding the compensating signal into a signal shaped by a frequency domain spectral shaping (FDSS) filter. Determining the one or more other frequency components for the non-SE part may further comprise multiplying output information from a Discrete Fourier Transform (DFT) process (or Fast Fourier Transform (FFT) process) with coefficients of a frequency domain spectral shaping (FDSS) filter. The SE part and the non-SE part may comprise one or more pluralities of sub-carriers in frequency-domain, respectively. The circuitry 1814 may be further configured to determine transport block size (TBS) for uplink transmission based on a total number of sub-carriers in the non-SE part. The non-SE part may include more sub-carriers than the SE part.

The receiver 1804 may, in operation, receive the control information via downlink control information (DCI), Medium Access Control Control Element (MAC CE) or Radio Resource Control (RRC), or via an implicit indication based on another signalling or configuration from a base station.

The circuitry 1814 may be configured to determine the SE part based on the non-SE part. The control information may indicate that the non-SE part is a legacy frequency domain resource assignment (FDRA) (BW_{legacy}) that is specified in a technical specification, and the circuitry 1814 may be further configured, in accordance with an indication in the control information, to determine the SE part as a plurality of sub-carriers or a number of physical resource blocks (PRBs), or determine the SE part based on a modulation order or a size of the legacy FDRA. the circuitry 1814 may be configured to determine the SE part based on a legacy FDRA (BW_{legacy}) and a parameter (α) indicated in the control information, the SE part being αBW_{legacy}. The control information may indicate a parameter pair (α,β), a indicating one or more sub-carriers for the SE part and β indicating one or more other sub-carriers for the non-SE part, and the circuitry 1814 may be configured to determine the SE part and non-SE part based on α and β respectively. The circuitry 1814 may be configured to determine, in accordance with the control information, a size of the SE part based on a frequency range (FR) of the SE part. The circuitry 1814 may be configured to determine a size of the SE part based on one or a combination of a spectral efficiency, or a value of maximum power reduction/peak-to-average power ratio (MPR/PAPR).

Further, the communication apparatus 1800 may be a base station or gNB, and the circuitry 1814 may, in operation, generate control information relating to a spectrum-extension (SE) part and a non-SE part of a signal, the control information indicating a resource allocation for the SE part and the non-SE part in frequency domain. The transmitter 1802 may, in operation, transmit the control information to a communication apparatus.

### (Control Signals)

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the first stage sidelink control information (SCI) or the second stage SCI.

### (Base Station)

In the present disclosure, the base station may be a Transmission Reception Point (TRP), a cluster head, an access point, a Remote Radio Head (RRH), an eNodeB (eNB), a gNodeB (gNB), a Base Station (BS), a Base Transceiver Station (BTS), a base unit or a gateway, for example. Further, in sidelink communication, a terminal may be adopted instead of a base station. The base station may be a relay apparatus that relays communication between a higher node and a terminal. The base station may be a roadside unit as well.

### (Uplink/Downlink/Sidelink)

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### (Data Channels/Control Channels)

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### (Reference Signals)

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### (Time Intervals)

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### (Frequency Bands)

The present disclosure may be applied to any of a licensed band and an unlicensed band.

### (Communication)

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### (Antenna Ports)

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

As described above, the embodiments of the present disclosure provide an advanced communication system, communication methods and communication apparatuses that advantageously integrate FDSS with spectrum extension and tone reservation.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

Some non-limiting examples of such communication apparatus include a phone (e.g., cellular (cell) phone, smart phone), a tablet, a personal computer (PC) (e.g., laptop, desktop, netbook), a camera (e.g., digital still/video camera), a digital player (e.g., digital audio/video player), a wearable device (e.g., wearable camera, smart watch, tracking device), a game console, a digital book reader, a telehealth/telemedicine (e.g., remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

Further described below are statements applying to various embodiments of the present invention:

Statement 1. A communication apparatus comprising: circuitry, which in operation: determines one or more frequency components for a spectrum-extension (SE) part and one or more other frequency components for a non-SE part of a signal based on control information relating to the SE part and the non-SE part; generates a compensating signal based on the one or more frequency components of the SE part; and generates a reduced peak signal based on the compensating signal; and a transmitter, which in operation, transmits the reduced peak signal.

Statement 2. The communication apparatus of Statement 1, wherein the reduced peak signal is generated by adding the compensating signal into a signal shaped by a frequency domain spectral shaping (FDSS) filter.

Statement 3. The communication apparatus of Statement 2, wherein the compensating signal is comprised of zero-value components in the non-SE part.

Statement 4. The communication apparatus of Statement 1, wherein determining the one or more other frequency components for the non-SE part comprises:

multiplying output information from a Discrete Fourier Transform (DFT) process with coefficients of a frequency domain spectral shaping (FDSS) filter.

Statement 5. The communication apparatus of Statement 4, wherein determining the one or more frequency components for the SE part comprises: copying an upper portion of the output information to an end of a lower portion of the non-SE part, and copying a lower portion of the output information to an end of the upper portion of the non-SE part; and forming the SE part by multiplying the copied upper and lower portions of the output information with coefficients of the FDSS filter.

Statement 6. The communication apparatus of Statement 1, wherein the SE part and the non-SE part comprises one or more pluralities of sub-carriers in frequency-domain, respectively.

Statement 7. The communication apparatus of Statement 1, wherein the circuitry is further configured to determine transport block size (TBS) for uplink transmission based on a total number of sub-carriers in the non-SE part.

Statement 8. The communication apparatus of Statement 6, wherein the non-SE part includes more sub-carriers than the SE part.

Statement 9. The communication apparatus of Statement 6, wherein the SE part is less than or equal to a size of the plurality of sub-carriers.

Statement 10. The communication apparatus of Statement 6, wherein the SE part includes more sub-carriers for a high modulation order than that for a low modulation order.

Statement 11. The communication apparatus of Statement 5, wherein the circuitry is further configured to apply a demodulation reference signal (DMRS) density size for the upper portion and the lower portion that is higher than a DMRS density size of the non-SE part before copying the upper portion and the lower portion of the output information.

Statement 12. The communication apparatus of Statement 5, wherein the circuitry is further configured to apply a DMRS density size for the formed SE part that is different from a DMRS density size of the non-SE part.

Statement 13. The communication apparatus of Statement 1, further comprising a receiver, which in operation, receives the control information via downlink control information (DCI), Medium Access Control Control Element (MAC CE) or Radio Resource Control (RRC), or via an implicit indication based on another signalling or configuration from a base station.

Statement 14. The communication apparatus of Statement 1, wherein the circuitry is configured to determine the SE part based on the non-SE part.

Statement 15. The communication apparatus of Statement 14, wherein a size of the determined SE part is smaller as a size of the non-SE part is larger.

Statement 16. The communication apparatus of Statement 14, wherein a ratio of a size of the determined SE part to a size of the non-SE part is smaller as the size of the non-SE part is larger.

Statement 17. The communication apparatus of Statement 1, wherein the control information indicates that the non-SE part is a legacy frequency domain resource assignment (FDRA) (BW_{legacy}) that is specified in a technical specification, and the circuitry is further configured, in accordance with an indication in the control information, to determine the SE part as a plurality of sub-carriers or a number of physical resource blocks (PRBs), or determine the SE part based on a modulation order or a size of the legacy FDRA.

Statement 18. The communication apparatus of Statement 1, wherein the circuitry is configured to determine the SE part based on a legacy FDRA (BW_{legacy}) and a parameter (α) indicated in the control information, the SE part being αBW_{legacy}.

Statement 19. The communication apparatus of Statement 18, wherein a bandwidth of the determined SE part is broader as a bandwidth of the non-SE part is broader.

Statement 20. The communication apparatus of Statement 18, wherein the circuitry is configured to determine the non-SE part as BW_{legacy} if the SE part is an additional part to BW_{legacy}, or determine the non-SE part as (1−α) BW_{legacy} if the SE part and non-SE part are confined within BW_{legacy}.

Statement 21. The communication apparatus of Statement 1, wherein the control information indicates a parameter pair (α, β), a indicating one or more sub-carriers for the SE part and β indicating one or more other sub-carriers for the non-SE part, and the circuitry is configured to determine the SE part and non-SE part based on α and β respectively.

Statement 22. The communication apparatus of Statement 1, wherein the circuitry is configured to determine, in accordance with the control information, a size of the SE part based on a frequency range (FR) of the SE part.

Statement 23. The communication apparatus of Statement 1, wherein the circuitry is configured to determine a size of the SE part based on one or a combination of a spectral efficiency, or a value of maximum power reduction/peak-to-average power ratio (MPR/PAPR).

Statement 24. The communication apparatus of Statement 1, wherein the circuitry is further configured to determine the SE part as a UE-specific value, or a UE type-specific value, or a serving-cell-specific value based on the control information.

Statement 25. A base station comprising: circuitry, which in operation, generates control information relating to a spectrum-extension (SE) part and a non-SE part of a signal, the control information indicating a resource allocation for the SE part and the non-SE part in frequency domain; and a transmitter, which in operation, transmits the control information to a communication apparatus.

Statement 26. A communication method comprising: determining one or more frequency components for a spectrum-extension (SE) part and one or more other frequency components for a non-SE part of a signal based on control information relating to the SE part and the non-SE part; generating a compensating signal based on the one or more frequency components of the SE part; and generating a reduced peak signal based on the compensating signal; and transmitting the reduced peak signal.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
circuitry, which in operation:
determines one or more frequency components for a spectrum-extension (SE) part and one or more other frequency components for a non-SE part of a signal based on control information relating to the SE part and the non-SE part;
generates a compensating signal based on the one or more frequency components of the SE part; and
generates a reduced peak signal based on the compensating signal; and
a transmitter, which in operation, transmits the reduced peak signal.

2. The communication apparatus of claim 1, wherein the reduced peak signal is generated by adding the compensating signal into a signal shaped by a frequency domain spectral shaping (FDSS) filter.

3. The communication apparatus of claim 1, wherein determining the one or more other frequency components for the non-SE part comprises:
multiplying output information from a Discrete Fourier Transform (DFT) process with coefficients of a frequency domain spectral shaping (FDSS) filter.

4. The communication apparatus of claim 1, wherein the SE part and the non-SE part comprises one or more pluralities of sub-carriers in frequency-domain, respectively.

5. The communication apparatus of claim 1, wherein the circuitry is further configured to determine transport block size (TBS) for uplink transmission based on a total number of sub-carriers in the non-SE part.

6. The communication apparatus of claim 1, wherein the non-SE part includes more sub-carriers than the SE part.

7. The communication apparatus of claim 1, further comprising a receiver, which in operation, receives the control information via downlink control information (DCI), Medium Access Control Control Element (MAC CE) or Radio Resource Control (RRC), or via an implicit indication based on another signalling or configuration from a base station.

8. The communication apparatus of claim 1, wherein the circuitry is configured to determine the SE part based on the non-SE part.

9. The communication apparatus of claim 1, wherein the control information indicates that the non-SE part is a legacy frequency domain resource assignment (FDRA) (BW_{legacy}) that is specified in a technical specification, and the circuitry is further configured, in accordance with an indication in the control information, to determine the SE part as a plurality of sub-carriers or a number of physical resource blocks (PRBs), or determine the SE part based on a modulation order or a size of the legacy FDRA.

10. The communication apparatus of claim 1, wherein the circuitry is configured to determine the SE part based on a legacy FDRA (BW_{legacy}) and a parameter (α) indicated in the control information, the SE part being αBW_{legacy}.

11. The communication apparatus of claim 1, wherein the control information indicates a parameter pair (α, β), a indicating one or more sub-carriers for the SE part and β indicating one or more other sub-carriers for the non-SE part, and the circuitry is configured to determine the SE part and non-SE part based on α and β respectively.

12. The communication apparatus of claim 1, wherein the circuitry is configured to determine, in accordance with the control information, a size of the SE part based on a frequency range (FR) of the SE part.

13. The communication apparatus of claim 1, wherein the circuitry is configured to determine a size of the SE part based on one or a combination of a spectral efficiency, or a value of maximum power reduction/peak-to-average power ratio (MPR/PAPR).

14. A base station comprising:
circuitry, which in operation, generates control information relating to a spectrum-extension (SE) part and a non-SE part of a signal, the control information indicating a resource allocation for the SE part and the non-SE part in frequency domain; and
a transmitter, which in operation, transmits the control information to a communication apparatus.

15. A communication method comprising:
determining one or more frequency components for a spectrum-extension (SE) part and one or more other frequency components for a non-SE part of a signal based on control information relating to the SE part and the non-SE part;
generating a compensating signal based on the one or more frequency components of the SE part; and
generating a reduced peak signal based on the compensating signal; and
transmitting the reduced peak signal.
